(19) United States
(12) Patent Application Publication
(10) Pub. No.: US 2007/0090917 A1
(43) Pub. Date: Apr. 26, 2007

(54) Vehicle dealership security system

(76) Inventor: Michael Boyden Parnaby, Durban (ZA)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/583,142

(22) Filed: Oct. 19, 2006

(30) Foreign Application Priority Data
Oct. 20, 2005 (ZA) 2005/08516

(51) Int. Cl. H04L 9/32

(52) U.S. Cl. 340/5.22; 340/5.28; 340/5.64; 340/5.72; 340/426.17; 340/5.25

(57) ABSTRACT

This invention relates to a vehicle dealership security system. The system includes a vehicle security system installed in each of a plurality of vehicles on display for sale on a shop floor of a vehicle dealership. All of the systems are configured to be disarmed by the same RF disarm signal. The vehicle dealership security system includes also a number of dealer remote controls for use by the dealership. Each remote control can be programmed to be functional for a limited duration only for transmitting the signal required to disarm the vehicle security systems, after which it disables itself and, to be functional again, must be reset by means of a strictly controlled resetting device. The purpose of the limited duration functionality is to limit the potential availability of functional remote controls to unauthorized persons who may want to use at the dealership.

### FIELD OF THE INVENTION

THIS INVENTION relates to a vehicle dealership security system.

### BACKGROUND TO THE INVENTION

It is known for a vehicle dealership to use a dealership security system which includes a vehicle security system installed in each of a plurality of vehicles displayed on the shop floor of the dealership, such installation of security systems on vehicles being referred to as preloading vehicles with security. This preloading not only serves the purpose of protecting the vehicles on the shop floor prior to sale, but also gives the dealership an opportunity to attempt to sell each security system on to a purchaser of a vehicle and to thus profit therefrom.

A vehicle security system, as herein envisaged, may include an alarm or an immobilizer or both and its operation is associated with at least one RF remote control that can be used for arming and disarming it. It may be linked to a locking system of a vehicle. While vehicles are on the shop floor of a dealership, the security systems on the vehicles are all configured to respond to an RF disarm signal linked to a common code. As such, the same remote control, also associated with this code and referred to herein as a dealer remote control, can be used for disarming the security system of any one of the vehicles on the shop floor. Each sales person of the dealership typically will be issued with one of these dealer remote controls to enable them to demonstrate vehicles to customers.

When a customer purchases a particular vehicle, the sales person concerned will attempt to sell the security system of the vehicle along with the vehicle. If successful, the security system is reconfigured to no longer be disarmed upon receiving the disarm signal emitted by the dealer remote control but upon receiving a unique coded disarm signal emitted by a remote control supplied to the customer.

A problem associated with the above vehicle dealership security system is that dealership shop floors can have large numbers of vehicles, even in excess of one thousand, displayed thereon, and the dealer remote controls are available to a large number of employees of the dealership, at least each sales person typically being issued with one. This ready availability of the dealer remote controls clearly constitutes a security risk and this risk is exacerbated when a sales person leaves the employ of a dealership and does not return his dealer remote control.

It is thus an object of this invention to at least ameliorate the above potential security risk associated with vehicle dealership security systems of the general type described above.

### SUMMARY OF THE INVENTION

According to a first aspect of the invention there is provided a vehicle dealership security system, including
a vehicle security system installed in each of a plurality of vehicles on display for sale on a shop floor of a vehicle dealership, all of the systems being configured to be disarmed by the same RF disarm signal, incorporating a dealer remote control code; and
a plurality of dealer remote controls, each of which includes a processor, including a timer, and provides a limited duration functional cycle, timed by its timer, during which it can be operated to transmit the said disarm signal and after which it disables such transmission.

The vehicle security systems may be ones that have been installed in the vehicles after arrival at the dealership, i.e. by way of preloading the vehicles with security. Insofar as such preloading is known, it will not be elaborated on herein.

Each dealer remote control may include input means providing for receiving an input for initiating a functional cycle thereof. The input means thus effectively provides for the remote control to be reset. The input means of each dealer remote control may provide for programming a duration of a functional cycle into the processor of the remote control. The processor of each dealer remote control may have the dealer remote control code stored therein for the duration of a functional cycle and may be configured to erase the dealer remote control code upon expiry of the cycle.

In the case of each dealer remote control of the vehicle dealership security system including input means, as referred to above, the input means of each dealer remote control may include a reed switch and the processor of the remote control may be configured to decode a sequence of switching operations performed on the reed switch into a data stream, providing for a suitable sequence of switching operations to yield a data stream including the dealer remote control code. The vehicle dealership security system may include a resetting device, including a magnetic field generator, the device providing for a dealer remote control code to be programmed into it and providing an operative mode thereof in which it activates its magnetic field generator in a sequence of on and off cycles corresponding to a sequence of switching operations on a reed switch of a dealer remote control which, upon being decoded by the processor of the remote control, will yield a data stream including the dealer remote control code.

In the case of each remote control of the vehicle dealership security system including input means providing for a duration to be programmed into the processor of each remote control of the system, the input means of each dealer remote control may provide for a dealer remote control code to be programmed into the processor of the remote control.

In the vehicle dealership security system, the vehicle security systems may be configured to be disarmed by the same RF disarm signal by each having the dealer remote control code stored therein, each vehicle security system providing for the dealer remote control code to be erased from it and for a unique code, associated with a remote control to be supplied to a buyer of the associated vehicle and the security system, to be programmed therein.

According to a second aspect of the invention there is provided a remote control for disarming a vehicle security system which includes at least one of an alarm and an immobilizer and which is configured to be disarmed by an RF disarm signal, incorporating a code stored in the system, the remote control including a processor, including a timer, and providing a limited duration functional cycle, timed by its timer, during which it can be operated to transmit the said disarm signal and after which it disables such transmission. The remote control may include input means providing for receiving an input for initiating a functional cycle thereof. The input means may provide for programming a duration of a functional cycle into the processor of the remote control. The processor may have the code stored therein for the duration of a functional cycle and may be configured to erase the code upon expiry of the cycle.

In the case of the remote control including input means providing for programming a duration of a functional cycle into its processor, the input means may include a reed switch and the processor may be configured to decode a sequence of switching operations performed on the reed switch into a data stream, providing for a suitable sequence of switching operations to yield a data stream including the code.

In the case of the remote control including input means providing for a duration to be programmed into its processor, the input means may provide for a code to be programmed into the processor.

The remote control of the second aspect of the invention may be provided for use as a dealer remote control in the vehicle dealership security system of the first aspect of the invention.

According to a third aspect of the invention there is provided a combination of a vehicle security system and a remote control, in which
the vehicle security system includes at least one of an alarm and an immobilizer and is configured to be disarmed by an RF disarm signal, incorporating a code stored in the system; and
the remote control includes a processor, including a timer, and provides a limited duration functional cycle, timed by its timer, during which it can be operated to transmit the said disarm signal and after which it disables such transmission.

Further features of the remote control of the vehicle security system of the third aspect of the invention may be in accordance with those of the remote control of the second aspect of the invention and are not repeated here.

The different aspects of the invention and the features associated therewith are described in more detail hereinafter with reference to an example of a vehicle dealership security system, in accordance with the first aspect of the invention, including remote controls, in accordance with the second aspect of the invention, with reference to and as illustrated in the accompanying diagrammatic drawings. The example will also cover a combination of a vehicle security system and a remote control, in accordance with the third aspect of the invention.

### BRIEF DESCRIPTION OF THE DRAWINGS

FIG. 1 shows diagrammatically a remote control, in accordance with the second aspect of the invention, which serves as a dealer remote control of a vehicle dealership security system, in accordance with the first aspect of the invention, and is also an example of a remote control of a combination of a vehicle security system and a remote control, in accordance with the third aspect of the invention.

FIG. 2 shows diagrammatically a resetting device for resetting the remote control of FIG. 1.

FIG. 3 shows a simplified flow diagram of the process of the remote control of FIG. 1.

### DETAILED DESCRIPTION OF THE DRAWINGS

A vehicle dealership security system, in accordance with the first aspect of the invention, is described hereafter, by way of example, with reference to its use by a vehicle dealership that has a large number of vehicles displayed for sale on its shop floor, say in excess of one thousand vehicles.

In order to provide for protection of the vehicles displayed on the shop floor, all the vehicles are preloaded with security, particularly by the installation of a vehicle security system in each vehicle, which security system may include at least one of an alarm, an immobilizer, and so forth. These vehicle security systems may be conventional and, as such, they are not illustrated or described in detail herein. In addition to providing for the protection of the vehicles on the shop floor of the vehicle dealership, the dealership also aims to sell the security system installed in each vehicle to a customer who buys the vehicle, particularly to profit from such a sale.

By having the same remote control code stored in each one of them, the vehicle security systems all are configured to be disarmed by the same coded RF disarm signal. This code is referred to hereinafter as the dealer remote control code. As such, the vehicle security systems may all be armed and disarmed via the same remote control, having the dealer remote control code stored therein. Such a remote control, used by the dealership, is referred to herein also as a dealer remote control.

The vehicle dealership security system of the current example includes the preloaded vehicle security systems referred to above, a number of identical dealer remote controls, being remote controls in accordance with the second aspect of the invention, and a resetting device.

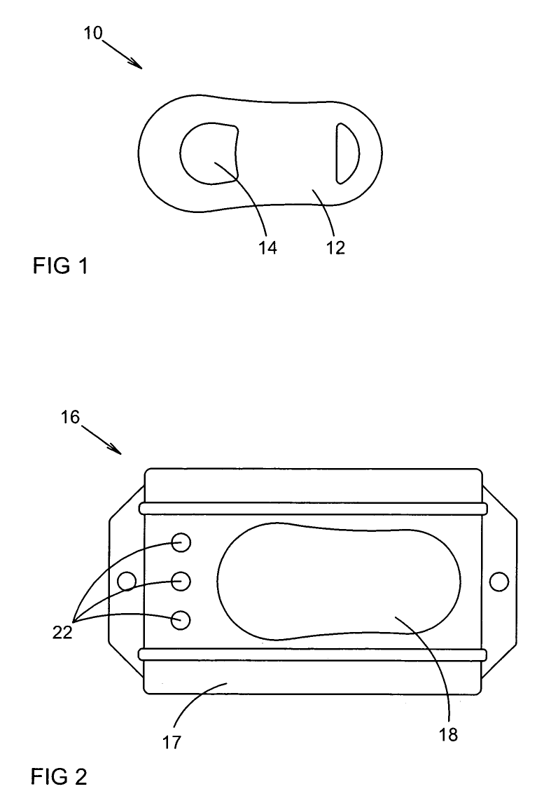

In FIG. 1, one of the dealer remote controls is shown, designated by the reference numeral 10. The dealer remote control 10 includes a housing 12, an electronic circuit (not shown), and a push button 14 for operating the circuit.

The electronic circuit of the remote control 10 includes a programmable processor, which has a memory in which the dealer remote control code is stored; a timer; a switch that is operated by the push button 14; input means including a reed switch; an RF transmitter; and a battery.

The reed switch of the remote control 10 is switchable by a compatible magnetic field generator and the processor can decode a sequence of switching operations performed on the reed switch into a digital data stream. For the sake of this example only, decoding in response to switching may occur as follows, assuming that the reed switch is normally open:
A reed switch closure of a duration of between 20 and 35 ms is decoded by the processor as a value “1”;
A reed switch closure of a duration of between 45 and 55 ms is decoded by the processor as a value “0”; and
All other durations of closure of the reed switch are ignored.

A suitable sequence of switching operations performed on the reed switch is decoded by the processor into a digital data stream. The processor is pre-programmed to validate such a data stream. A valid data stream includes a duration value and a code that are readable by the processor.

In FIG. 2, the resetting device of the vehicle dealership security system is designated generally by the reference numeral 16. The device includes a body 17 and an electronic circuit (not shown), which includes a processor, a memory, a magnetic field generator in the form of an electromagnet, a series of dip switches, a series of indicator lights 22, and a power supply. The body 17 defines a recess 18 in an operative top surface thereof for receiving a bottom portion of any one of the dealer remote controls, including the remote control 10 of FIG. 1.

With reference to FIGS. 1 and 2, the resetting device 16 may be used to program the remote control 10 as follows. Placing the remote control 10 in the recess 18 of the resetting device 16 and pressing the button 14 of the remote control will cause the device 16 to energize its electromagnet in a sequence of on and off cycles, incorporating a particular duration and a code. The reed switch of the remote control 10 is switched in a corresponding sequence, serving as an input to the processor of the remote control. The processor decodes the switching sequence into a corresponding data stream and reads the duration and the code from the data stream and stores them in its memory.

A significant benefit of the above described method of programming a remote control is that it does not require opening the housing of a remote control.

The duration and dealer remote control code may be selected via dip switches of the resetting device, and the time period may be of limited duration, say one week or one month, or infinite. For use in the vehicle dealership security system, it will normally be of limited duration.

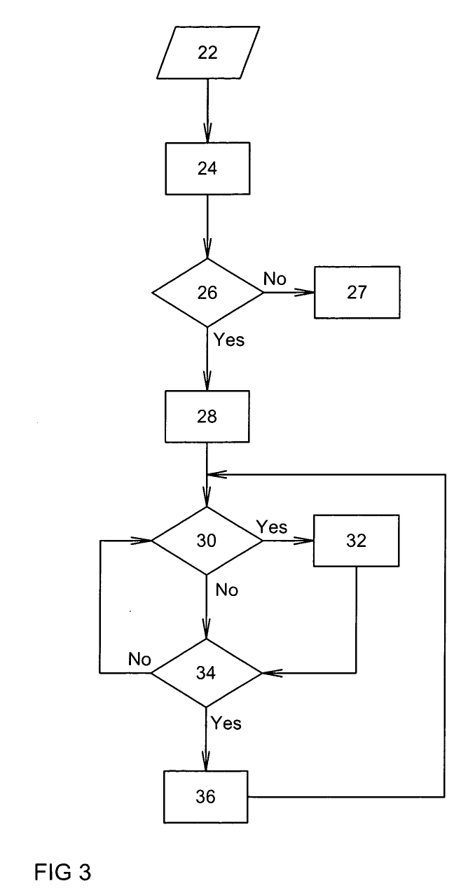

The process of the remote control 10 will now be further described with reference to the flow chart of FIG. 3 and the reference numerals appearing in it:
22: A sequence of switching operations performed on the reed switch via the resetting device 16 of FIG. 2, as described above, serves as an input to the processor.
24: The processor decodes the sequence of switching operations into a digital data stream.
26: The processor checks whether the data stream is valid by attempting to read a duration and a code from it.
27: The process ends.
28: The processor stores the duration and code in its memory and initiates timing of a functional cycle via its timer.
30: The processor checks whether an input has been made via the switch operated by the push button 14 of FIG. 1.
32: The remote control emits a coded RF signal including the code stored at 28 and if this is the dealer remote control code, the signal will disarm all armed vehicle security systems within range.
34: The processor determines from the timer whether the time elapsed since 28 exceeds the stored duration.
36: The code stored at 28 is erased by replacing it with a dummy code. Further transmissions of signals at 32 will include the dummy code and will not disarm the vehicle security systems.

For the purpose of the vehicle dealership security system, the code that will be stored at 28 in the processor of the remote control is the dealer remote control code. The period between 28 and 34 is thus a limited duration functional cycle of the remote control 10, during which pressing its button 14 (see FIG. 1) will cause it to transmit an RF signal that will disarm the vehicle security systems that are within range and armed. The duration of this period is the duration stored in the processor of the remote control 10 via the resetting device 16 of FIG. 2. After this period has expired, such transmission is disabled and further transmissions of signals will include the dummy code.

In an alternative embodiment vehicle dealership security system, in accordance with the first aspect of the invention, which is not illustrated, a limited duration functional cycle may remain stored in the memory of each remote control and the resetting device may merely be used to reset each remote control to initiate its functional cycle. It is thus not an essential requirement of the vehicle dealership security system of the invention that the duration of the functional cycle is communicated to a remote control every time it is reset.

In the dealership of the current example, only a person who is an authorized person has access to the resetting device 16. It will be assumed for the purpose of this example that it is dealership policy to activate dealer remote controls for functional cycles of one week. After a dealer remote control has been activated for one week, it is handed to a sales person, who is then able to use it for this duration, particularly in order to disarm security systems of vehicles being displayed. In order to ensure uninterrupted operation of his remote control, the sales person must return the remote control to the authorized person before the expiry of the functional cycle to have it reset. The remote control may, alternatively, be reset after expiry of the functional cycle.

It will be understood that by rendering the dealer remote control functional for limited durations only, excessive availability of the dealer remote controls that potentially can be used for gaining unauthorized access to vehicles is at least greatly reduced. Also, should a sales person leave the employ of a dealership and not return his dealer remote control, the remote control will be disabled upon the expiry of the duration referred to, and the remote control thus cannot be used thereafter in order to gain access to vehicles displayed on the dealership shop floor.

Should a customer decide to purchase a particular vehicle that has been preloaded with security, as described, the sales person concerned will attempt to sell the vehicle security system also. If successful, the vehicle security system is reconfigured to no longer be disarmed upon receiving the signal transmitted by the dealer remote control but upon receiving a unique coded signal emitted by a remote control supplied to the customer. This is typically achieved by deleting the dealer remote control code from the security system of the vehicle and storing therein a unique code associated with the remote control supplied to the customer.

The above example explains how the dealer remote controls are functional only for a limited duration functional cycle for disarming the vehicle security systems. The same limited duration will typically also apply to arming of the vehicle security systems via the dealer remote controls, but as this feature is not essential to the invention, it is not elaborated on herein.

It must be further understood that the configuration of the dealer remote control and the resetting device and particularly also the mode of communication between them may vary greatly from that described above. As such, the invention extends to any vehicle dealership security system, remote control, and resetting device including the essential features of a vehicle dealership security system, remote control, and resetting device, respectively, as herein envisaged.

A combination including any one of the vehicle security systems of the vehicle dealership security system of the above example and the remote control 10 of the example also is an example of a combination, in accordance with the third aspect of the invention.

1. A vehicle dealership security system, including
a vehicle security system installed in each of a plurality of vehicles on display for sale on a shop floor of a vehicle dealership, all of the systems being configured to be disarmed by the same RF disarm signal, incorporating a dealer remote control code; and
a plurality of dealer remote controls, each of which includes a processor, including a timer, and provides a limited duration functional cycle, timed by its timer, during which it can be operated to transmit the said disarm signal and after which it disables such transmission.

2. A vehicle dealership security system as claimed in claim 1, in which each dealer remote control includes input means providing for receiving an input for initiating a functional cycle thereof.

3. A vehicle dealership security system as claimed in claim 2, in which the input means of each dealer remote control provides for programming a duration of a functional cycle into the processor of the remote control.

4. A vehicle dealership security system as claimed in claim 3, in which the processor of each dealer remote control has the dealer remote control code stored therein for the duration of a functional cycle and is configured to erase the dealer remote control code upon expiry of the cycle.

5. A vehicle dealership security system as claimed in claim 3, in which the input means of each dealer remote control includes a reed switch and the processor of the remote control is configured to decode a sequence of switching operations performed on the reed switch into a data stream, providing for a suitable sequence of switching operations to yield a data stream including the dealer remote control code.

6. A vehicle dealership security system as claimed in claim 5, which includes a resetting device, including a magnetic field generator, the device providing for a dealer remote control code to be programmed into it and providing an operative mode thereof in which it activates its magnetic field generator in a sequence of on and off cycles corresponding to a sequence of switching operations on a reed switch of a dealer remote control which, upon being decoded by the processor of the remote control, will yield a data stream including the dealer remote control code.

7. A vehicle dealership security system as claimed in claim 3, in which the input means of each dealer remote control provides for a dealer remote control code to be programmed into the processor of the remote control.

8. A vehicle dealership security system as claimed in claim 1, in which the vehicle security systems are configured to be disarmed by the same RF disarm signal by each having the dealer remote control code stored therein, each vehicle security system providing for the dealer remote control code to be erased from it and for a unique code, associated with a remote control to be supplied to a buyer of the associated vehicle and the security system, to be programmed therein.

9. A remote control for disarming a vehicle security system which includes at least one of an alarm and an immobilizer and which is configured to be disarmed by an RF disarm signal, incorporating a code stored in the system, the remote control including a processor, including a timer, and providing a limited duration functional cycle, timed by its timer, during which it can be operated to transmit the said disarm signal and after which it disables such transmission.

10. A remote control as claimed in claim 9, which includes input means providing for receiving an input for initiating a functional cycle thereof.

11. A remote control as claimed in claim 10, in which the input means provides for programming a duration of a functional cycle into the processor of the remote control.

12. A remote control as claimed in claim 11, in which the processor has the code stored therein for the duration of a functional cycle and is configured to erase the code upon expiry of the cycle.

13. A remote control as claimed in claim 11, in which the input means includes a reed switch and the processor is configured to decode a sequence of switching operations performed on the reed switch into a data stream, providing for a suitable sequence of switching operations to yield a data stream including the code.

14. A remote control as claimed in claim 11, in which the input means provides for a code to be programmed into the processor of the remote control.

15. A remote control as claimed in claim 9, provided for use as a dealer remote control in a vehicle dealership security system including
a vehicle security system installed in each of a plurality of vehicles on display for sale on a shop floor of a vehicle dealership, all of the systems being configured to be disarmed by the same RF disarm signal, incorporating a dealer remote control code; and
a plurality of dealer remote controls, each of which includes a processor, including a timer, and provides a limited duration functional cycle, timed by its timer, during which it can be operated to transmit the said disarm signal and after which it disables such transmission.

16. A combination of a vehicle security system and a remote control, in which
the vehicle security system includes at least one of an alarm and an immobilizer and is configured to be disarmed by an RF disarm signal, incorporating a code stored in the system; and
the remote control includes a processor, including a timer, and provides a limited duration functional cycle, timed by its timer, during which it can be operated to transmit the said disarm signal and after which it disables such transmission.
